(19) United States
(12) Patent Application Publication
(10) Pub. No.: US 2007/0146275 A1
(43) Pub. Date: Jun. 28, 2007

(54) Liquid crystal display and method for driving the same

(75) Inventor: Jin Suk Choi, Seoul (KR)

Correspondence Address: SEYFARTH SHAW, LLP, 815 CONNECTICUT AVENUE, N.W., SUITE 500, WASHINGTON, DC, 20006, US

(73) Assignee: LG. PHILIPS LCD CO., LTD., Seoul (KR)

(21) Appl. No.: 11/455,821

(22) Filed: Jun. 20, 2006

(30) Foreign Application Priority Data
Dec. 22, 2005 (KR) 10-2005-0128073

(51) Int. Cl. G09G 3/36

(52) U.S. Cl. 345/92

(57) ABSTRACT

A liquid crystal display panel includes a plurality of gate lines and a plurality of data lines crossing each other to define liquid crystal cells, a first switching element in each liquid crystal cell connected to a data line, a second switching element in each liquid crystal cell connected to the first switching element and a common voltage, and a pixel electrode connected to the first and second switching elements.

The present invention claims the benefit of Korean Patent Application No. 2005-0128073 filed in Korea on Dec. 22, 2005, which is hereby incorporated by reference in its entirety.

### BACKGROUND OF THE INVENTION

1. Field of the Invention

The present invention relates to a display device, and more particularly, to a liquid crystal display and a method for driving the same. Although the present invention is suitable for a wide scope of applications, it is particularly suitable for suppressing a screen afterimage.

2. Background of the Related Art

In the information-oriented society, the role of electronic displays is important since various types of electronic displays are widely used. As electronic displays evolve, new functions for various needs of the information-oriented society are continuously being added. In general, the electronic displays convey information to human beings through visual images. In other words, electronic displays change electronic information signals output from various electronic apparatuses into optical information signals that can be seen by human eyes to communicate information to human beings.

Electronic displays can be an emission type display in which the optical information signals are displayed by light emission from the display or a light reception type display in which the optical information signals are displayed by optical modulation of light passing through the display. Examples of emission type displays, also referred to as active displays, include cathode ray tubes (CRTs), plasma display panels (PDP), organic electroluminescent displays (OELD), and light emitting diodes (LED). Examples of light reception type displays, also referred to as passive displays, include liquid crystal displays (LCD) and electrophoretic image displays (EPID). CRTs have been used in televisions and computer monitors for a long time and have a large market share due to their low cost. However, the CRTs have disadvantages, such as heavy weight, large bulk, and high power consumption.

The use of flat panel displays (FPD) is rapidly increasing because they are thinner, lighter and consume a relatively small amount of power. Examples of FPDs include LCDs, plasma display panels (PDP), and organic electroluminescence displays (OELD). In an LCD, a liquid crystal material having an anisotropic dielectric constant is injected between a color filter substrate and an array substrate. The color filter substrate includes a common electrode, color filters, and black matrix. The array substrate includes switching devices and pixel electrodes connected to the switching devices. To operate the LCD, different electric potentials are applied to the pixel electrodes and the common electrode so that the intensity of the electric field formed across the liquid crystal material controls the orientation of the liquid crystal the molecules of the liquid crystal material, so as to control the amount of light that passes through the array substrate to display a desired image. Typically, thin film transistors (TFTs) are used in the LCDs.

FIG. 1 is a circuit diagram of a related art liquid crystal display. As shown in FIG. 1, the related art liquid crystal display has a liquid crystal panel 10, a data driver 30 for driving a plurality of data lines DL1 to DLm, and a gate driver 20 for driving a plurality of gate lines GL1 to GLn. The liquid crystal panel 10 has thin film transistors TFT at each crossing of the gate lines GL1 to GLn and the data lines DL1 to DLm. Liquid crystal cells are in a matrix defined by the gate lines GL1 to GLn and the data lines DL1 to DLm.

FIG. 2 is a waveform diagram of gate signals supplied to the liquid crystal display shown in FIG. 1. The gate driver 20 sequentially applies gate signals, as shown in FIG. 2, to the gate lines GL1 to GLn so as to transmit data signals from the data lines DL1 to DLm to the liquid crystal cells in response to the gate signals from the gate lines GL1 to GLn. The thin film transistor (TFT) is an N-type thin film transistor provided with an n-channel, which is turned on by a gate high voltage Vgh of the gate signals and turned off by a gate low voltage Vgl of the gate signals.

A liquid crystal cell can be equivalently expressed as a liquid crystal capacitor Clc because a liquid crystal cell includes a common electrode opposed to a pixel electrode with a liquid crystal therebetween. The liquid crystal cell is also provided with a storage capacitor Cst formed between the pixel electrode of the liquid crystal cell and the pre-stage gate line to store a voltage on the pixel electrode received from a data signal. A change in the voltage on the pixel electrode to the next voltage on the pixel electrode for a subsequent data signal will be inaccurate since a DC voltage component will remain due to a parasitic capacitance of the thin film transistor TFT while the gate high voltage Vgh of the gate signal changes into the gate low voltage Vgl. Such DC voltage component will remain when a next low data signal is to be charged onto the liquid crystal capacitor Clc after a previous high data signal. If the next data signal is at a voltage lower than the remaining DC voltage component, the subsequent data signal will not be charged onto the liquid crystal capacitor Clc to the correct voltage level, which reflects the next data signal. Instead, the DC voltage component will remain as incorrect voltage, thereby causing a screen afterimage.

### SUMMARY OF THE INVENTION

Accordingly, the present invention is directed to a liquid crystal display and a method for driving the same that substantially obviate one or more of the problems due to limitations and disadvantages of the related art.

An object of the present invention is to suppress an afterimage.

Another object is to completely discharge a pixel electrode prior to charging the voltage of a data signal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display panel includes a plurality of gate lines and a plurality of data lines crossing each other to define liquid crystal cells, a first switching element in each liquid crystal cell connected to a data line, a second switching element in each liquid crystal cell connected to the first switching element and a common voltage, and a pixel electrode connected to the first and second switching elements.

In another aspect, a liquid crystal display device includes a plurality of gate lines and a plurality of data lines crossing each other to define liquid crystal cells, a gate driver for sequentially supplying first and second gate signals to each of the plurality of gate lines, a data driver for sequentially supplying data signals to each of the plurality of data lines, a first switching element in each liquid crystal cell connected to a data line for switching the data signals to the liquid crystal cells in response to the first gate signals, and a second switching element in each liquid crystal cell connected to the first switching element and a common voltage for switching a common voltage to the liquid crystal cells in response to the second gate signals.

In another aspect, a method for driving a liquid crystal display panel having a plurality of gate lines and a plurality of data lines crossing each other to define liquid crystal cells, first switching elements in liquid crystal cells connected to a data line, second switching elements in liquid crystal cells connected to a common voltage, and pixel electrodes connected to the first and second switching elements, the method includes supplying data signals to the liquid crystal cells through the first switching elements in response to first gate signals, and supplying a common voltage to the liquid crystal cells through the second switching elements in response to second gate signals.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a circuit diagram of a related art liquid crystal display;

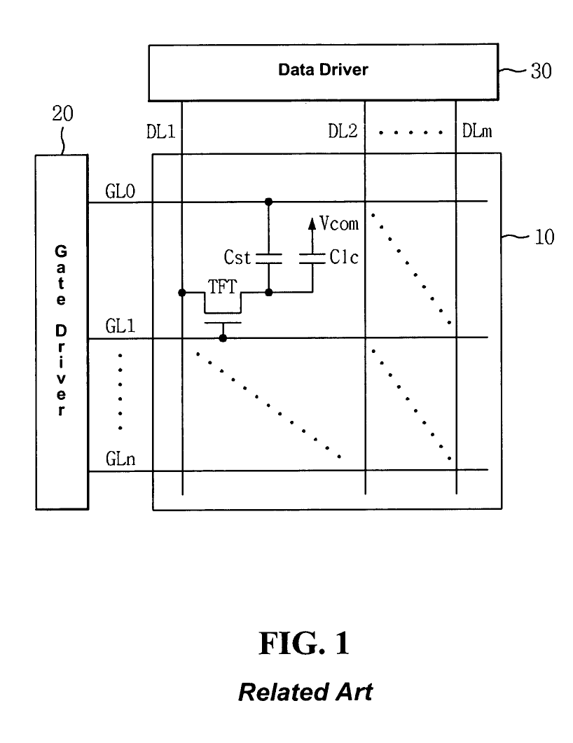

FIG. 2 is a waveform diagram of gate signals supplied to the liquid crystal display shown in FIG. 1;

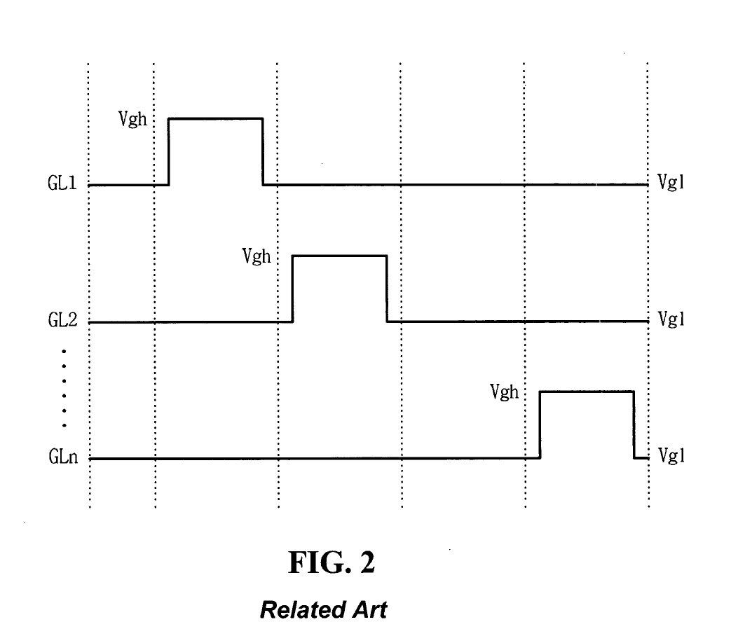

FIG. 3 is a block diagram of a liquid crystal display in accordance with a first embodiment of the present invention;

FIG. 4 is a waveform diagram of gate signals supplied to the liquid crystal display shown in FIG. 3;

FIG. 5 is a block diagram of a liquid crystal display in accordance with a second embodiment of the present invention; and

FIG. 6 is a waveform diagram of gate signals supplied to the liquid crystal display shown in FIG. 5.

### DETAILED DESCRIPTION OF THE PREFERRED EMBODIMENTS

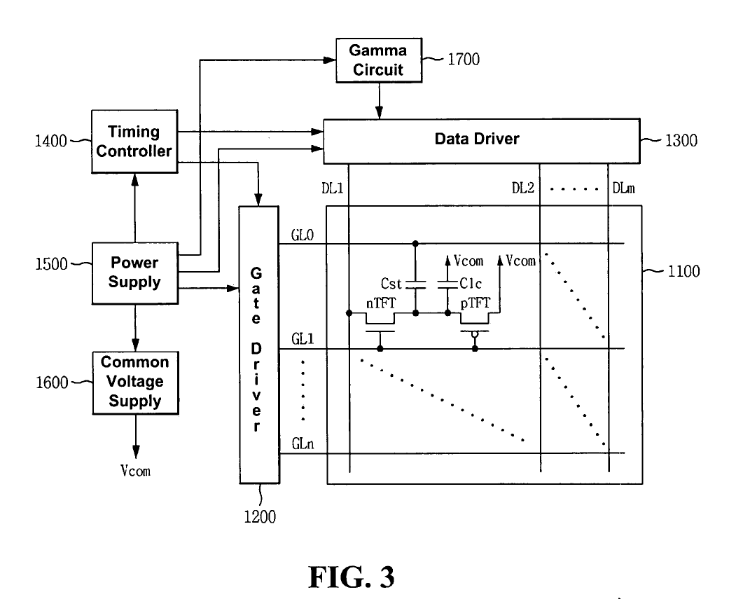

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. Hereinafter, a liquid crystal display and a method for driving the same in accordance with exemplary embodiments of the present invention will be described in detail with reference to FIGS. 3 to 6.

FIG. 3 is a block diagram of a liquid crystal display in accordance with a first embodiment of the present invention. As shown in FIG. 3, the liquid crystal display in accordance with a first embodiment of the present invention includes a liquid crystal panel 1100, a gate driver 1200 for driving a plurality of gate lines GL1 to GLn of the liquid crystal display panel 1100, a data driver for driving a plurality of data lines DL1 to DLm of the liquid crystal display panel 1100, a timing controller 1400 for controlling a driving timing of the data driver 1200 and the gate driver 1400, a power supply 1500 for supplying power, a gamma circuit 1700 for supplying a gamma voltage to the data driver 1300, and a common voltage supply 1600 for supplying a common voltage Vcom. The power supply 1500 generates driving voltages, such as the gate high voltage Vgh and the gate low voltage Vgl, and supplies the driving voltages to the timing controller 1400, the gate driver 1200, the gamma circuit 1700 and the common voltage supply 1600. The timing controller 1400 receives a data clock signal DCLK, a horizontal synchronization signal Hsync, a vertical synchronization signal Vsync, a data enable signal DE, and a data signal Data. The timing controller 1400 supplied with the data signal Data relays the data signal Data to provide it to the data driver 1300. The timing controller 1400 supplied with the data clock signal DCLK, the horizontal synchronization signal Hsync, the vertical synchronization signal Vsync and the data enable signal DE generates timing signals for controlling the timing of the gate driver 1200 and the data driver 1300 and control signals such as a polarity inversion signal.

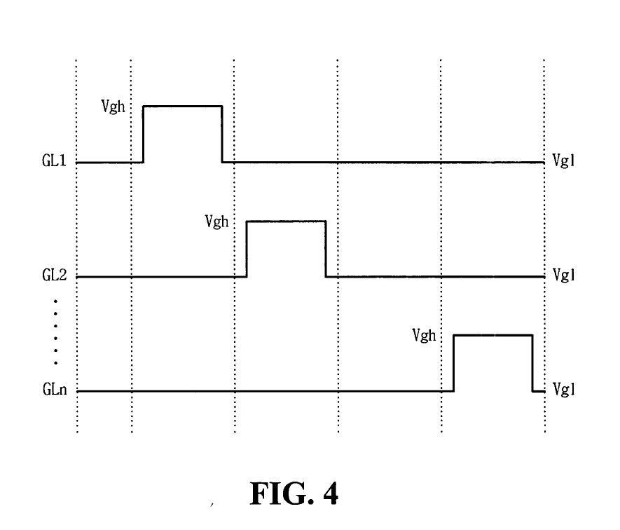

FIG. 4 is a waveform diagram of gate signals supplied to the liquid crystal display shown in FIG. 3. The gate driver 1200 sequentially applies the gate signals, as shown in FIG. 4, to the gate lines GL1 to GLn in response to a control signal from the timing controller 1400. The data driver 1300 applies the data signals Data to the data lines DL1 to DLm in response to a control signal supplied from the timing controller 1400.

As shown in FIG. 3, the plurality of gate lines GL1 to GLn and the plurality of data lines DL1 to DLm of the liquid crystal display panel 1100 cross each other and define liquid crystal cells in a matrix. A first switching element nTFT is formed at each crossing of the plurality of gate lines GL1 to GLn and the plurality of data lines DL1 to DLm. A second switching element pTFT is connected to the first switching element nTFT in each of the liquid crystal cells. As shown in FIG. 3, both of the first and second switching elements nTFT and pTFT of a liquid crystal cell are connected to the same gate line.

The first switching elements nTFT transmit the data signal Data from the data lines DL1 to DLm to the pixel electrodes of the liquid crystal cells in response to the gate signals from the gate lines GL1 to GLn. The second switching elements pTFT transmit the common voltage Vcom to the pixel electrodes of the liquid crystal cells in response to the gate signals from the gate lines GL1 to GLn. A first switching element nTFT is an n-type thin film transistor with an n-channel, and a second switching element pTFT is a p-type thin film transistor with a p-channel.

The liquid crystal cell may be equivalently expressed as a liquid crystal capacitor Clc because liquid crystal cell has a common electrode opposed to a pixel electrode with a liquid crystal therebetween. The pixel electrode is connected to both the first switching element nTFT and the second switching element pTFT. The common electrode is supplied with the common voltage Vcom from the common voltage supply 1600. Further, the liquid crystal cell includes a storage capacitor Cst with a pre-stage gate line GL0 to maintain the voltage of the data signal charged into the liquid crystal capacitor Clc by a data signal.

In the case where the first switching element nTFT is an n-type thin film transistor, the first switching element nTFT is turned on by the gate high voltage Vgh of the gate signal to transmit the data signal Data to the pixel electrode of the liquid crystal cell, and the first switching element nTFT is turned off by the gate low voltage Vgl of the gate signal to prevent transmission of the data signal Data from the data lines DL1 to DLm to the pixel electrode of the liquid crystal cell. In other words, the first switching element nTFT transmits the voltage of the data signal Data to the pixel electrode of the liquid crystal capacitor Clc while the gate signal is a gate high voltage Vgh.

In the case where the second switching element pTFT is a p-type thin film transistor, the second switching element pTFT is turned on by the gate low voltage Vgl of the gate signal to transmit the common voltage Vcom to the pixel electrode of a liquid crystal cell, and the second switching element pTFT is turned off by the gate high voltage Vgh of the gate signal to prevent transmission of the common voltage Vcom to the pixel electrode of the liquid crystal cell. In other words, the second switching element pTFT transmits the common voltage Vcom to the pixel electrode of the liquid crystal capacitor Cls while the gate signal is a gate low voltage Vg, while the first switching element nTFT prevents transmission of the voltage of the data signal Data to the pixel electrode of the liquid crystal capacitor Clc because the nTFT is turned off by the gate signal being a gate low voltage Vgl.

In a liquid crystal display in accordance with the first embodiment of the present invention, the data signal Data is transmitted to the pixel electrode of a liquid crystal cell through the first switching element nTFT and the common voltage Vcom is transmitted to the pixel electrode of the liquid crystal cells through the second switching element pTFT while no data signal Data is transmitted through the first switching elements nTFT. Thus, because the common voltage Vcom is transmitted to both electrodes of the liquid crystal capacitor Clc while no data signal Data is transmitted to the liquid crystal capacitor Clc, the DC voltage component remaining in the liquid crystal capacitor Clc can be removed prior to the charging of the next data signal. Thus, an afterimage caused by a DC voltage component remaining in the liquid crystal capacitor Clc can be prevented because the next data signal is accurately by being charged into a completely discharged liquid crystal capacitor Clc.

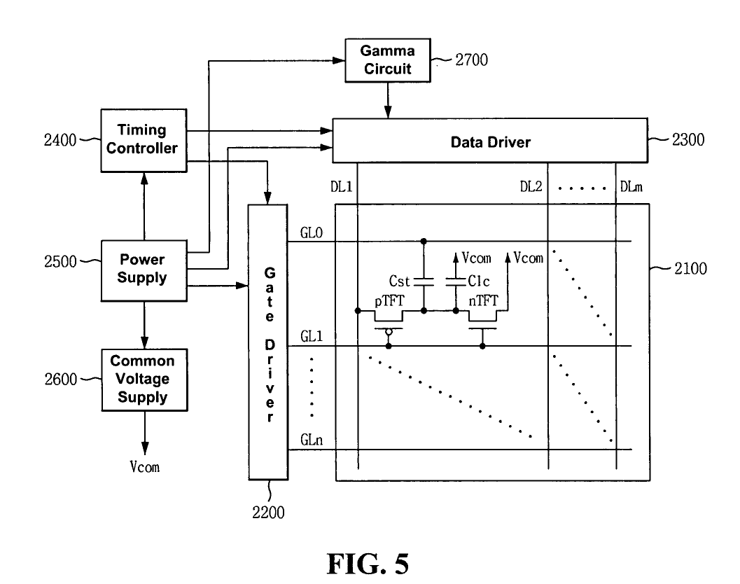

FIG. 5 is a block diagram of a liquid crystal display in accordance with a second embodiment of the present invention. The liquid crystal display in accordance with a second embodiment of the present invention includes a liquid crystal panel 2100, a gate driver 2200 for driving a plurality of gate lines GL1 to GLn of the liquid crystal display panel 2100, a data driver for driving a plurality of data lines DL1 to DLm of the liquid crystal display panel 2100, a timing controller 2400 for controlling or controlling a driving timing of the data driver 2200 and the gate driver 2400, a power supply 2500 for supplying power, a gamma circuit 2700 for supplying a gamma voltage to the data driver 2300, and a common voltage supply 2600 for supplying a common voltage Vcom. In the liquid crystal display in accordance with the second embodiment of the present invention, the description of the same parts as those of the liquid crystal display in accordance with the first embodiment of the present invention will be omitted, and only parts different from those of the liquid crystal display in accordance with the first embodiment of the present invention will be now described.

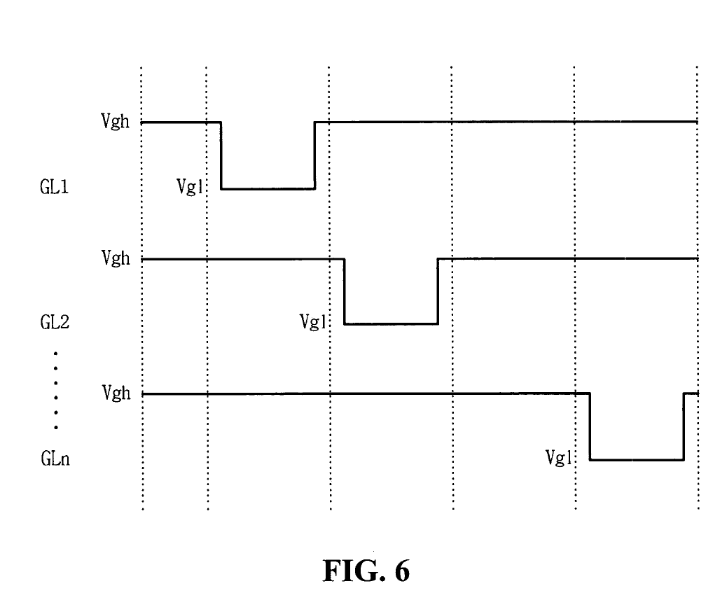

FIG. 6 is a waveform diagram of gate signals supplied to the liquid crystal display shown in FIG. 5. The gate driver 2200 sequentially applies the gate signals, as shown in FIG. 6, to the gate lines GL1 to GLn in response to a control signal from the timing controller 2400. The data driver 2300 applies the data signals Data to the data lines DL1 to DLm in response to a control signal supplied from the timing controller 2400.

As shown in FIG. 5, the plurality of gate lines GL1 to GLn and the plurality of data lines DL1 to DLm of the liquid crystal display panel 2100 cross each other and define liquid crystal cells in a matrix. A first switching element pTFT is formed at each crossing of the plurality of gate lines GLI to GLn and the plurality of data lines DL1 to DLm. A second switching element nTFT is connected to the first switching element pTFT in each of the liquid crystal cells. As shown in FIG. 3, both of the first and second switching elements pTFT and nTFT of a liquid crystal cell are connected to the same gate line.

The first switching elements pTFT transmit the data signal Data from the data lines DL1 to DLm to the pixel electrodes of liquid crystal cells in response to gate signals from the gate lines GL1 to GLn. The second switching elements nTFT transmit the common voltage Vcom to the pixel electrodes of the liquid crystal cells in response to gate signals form the gate lines GL1 to GLn. The first switching element pTFT is a p-type thin film transistor with a p-channel and the second switching element nTFT is an n-type thin film transistor with a n-channel.

In the case where the first switching element pTFT is a p-type thin film transistor, the first switching element pTFT is turned on by the gate low voltage Vgl of the gate signal to transmit the data signal Data to the pixel electrode of a liquid crystal cell, and the first switching element pTFT is turned off by the gate high voltage Vgh of the gate signal to prevent transmission of the data signal Data from the data lines DL1 to DLm to the pixel electrode of eh the liquid crystal cell. In other words, the first switching element pTFT transmits the voltage of the data signal Data to the pixel electrode of the liquid crystal capacitor Clc while the gate signal is a gate low voltage Vgl.

In the case where the second switching element nTFT is an n-type thin film transistor, the second switching element nTFT is turned on by the gate high voltage Vgh of the gate signal to transmit the common voltage Vcom to the pixel electrode of a liquid crystal cell, and the second switching element nTFT is turned off by the gate low voltage Vgl of the gate signal to prevent transmission of the common voltage Vcom to the pixel electrode of the liquid crystal cell. In other words, the second switching element nTFT transmits the common voltage Vcom to the pixel electrode of the liquid crystal capacitor Cls while the gate signal is a gate high voltage Vgh while the first switching element pTFT does not transmit the voltage of the data signal Data to the other electrode of the liquid crystal capacitor Clc because it is turned off by the gate signal being at a gate high voltage Vgl.

In the liquid crystal display in accordance with the second embodiment of the present invention, the data signal Data is transmitted to the pixel electrode of a liquid crystal cell through the first switching element pTFT, which is a p-type thin film transistor, and the common voltage Vcom is transmitted to the pixel electrode of the liquid crystal cell through the second switching element nTFT, which is an n-type thin film transistor while no data signal Data is transmitted through the first switching element pTFT. Thus, because the common voltage Vcom is transmitted to both electrodes of the liquid crystal capacitor Clc while no data signal Data is transmitted to the liquid crystal capacitor Clc, the voltage of the DC component remaining in the liquid crystal capacitor Clc can be removed prior to the charging of the next data signal. Thus, an afterimage caused by a DC voltage component remaining in the liquid crystal capacitor Clc can be prevented.

In the liquid crystal display and the method for driving the same in accordance with embodiments of the present invention, the data signal is transmitted to the liquid crystal cells through the first switching element, and the common voltage is transmitted to the liquid crystal cells through the second switching element while no data signal is transmitted to the liquid crystal cells through the first switching element. Thus, because the voltage transmitted to both electrodes of the liquid crystal capacitor while no data signal is transmitted to the liquid crystal capacitor is at the same common voltage, any remaining DC voltage component n the liquid crystal capacitor is removed such that the voltage of a subsequent data signal can be accurately charge onto the pixel electrode. Thus, an afterimage caused by a remaining DC voltage component in the liquid crystal capacitor is removed prior to the application of a subsequent data signal.

It will be apparent to those skilled in the art that various modifications and variations can be made in the liquid crystal display and a method for driving the same of the present invention without departing from the spirit or scope of the invention. Thus, it is intended that the present invention cover the modifications and variations of this invention provided they come within the scope of the appended claims and their equivalents.

What is claimed is:

1. A liquid crystal display panel, comprising:
a plurality of gate lines and a plurality of data lines crossing each other to define liquid crystal cells;
a first switching element in each liquid crystal cell connected to a data line;
a second switching element in each liquid crystal cell connected to the first switching element and a common voltage; and
a pixel electrode connected to the first and second switching elements.

2. The liquid crystal display panel of claim 1, wherein the first and second switching elements includes transistors.

3. The liquid crystal display panel of claim 2, wherein the first switching element includes an n-type thin film transistor, and the second switching element includes a p-type thin film transistor.

4. The liquid crystal display of claim 2, wherein the first switching element includes a p-type thin film transistor, and the second switching element includes an n-type thin film transistor.

5. The liquid crystal display of claim 1, wherein both of the first and second switching elements of a liquid crystal cell are connected to the same gate line.

6. The liquid crystal display of claim 1, wherein the pixel electrode extends over a pre-stage gate line to form a storage capacitor.

7. A liquid crystal display device, comprising:
a plurality of gate lines and a plurality of data lines crossing each other to define liquid crystal cells;
a gate driver for sequentially supplying first and second gate signals to each of the plurality of gate lines;
a data driver for sequentially supplying data signals to each of the plurality of data lines;
a first switching element in each liquid crystal cell connected to a data line for switching the data signals to the liquid crystal cells in response to the first gate signals; and
a second switching element in each liquid crystal cell connected to the first switching element and a common voltage for switching a common voltage to the liquid crystal cells in response to the second gate signals.

8. The liquid crystal display device of claim 7, wherein the second switching element is turned off by the first gate signal.

9. The liquid crystal display device of claim 7, wherein the first switching element is turned off by the second gate signal.

10. The liquid crystal display device of claim 7, wherein the first and second switching elements include transistors.

11. The liquid crystal display device of claim 10, wherein the first switching element includes an n-type thin film transistor, and the second switching element includes a p-type thin film transistor.

12. The liquid crystal display device of claim 10, wherein the first switching element includes a p-type thin film transistor, and the second switching element includes an n-type thin film transistor.

13. The liquid crystal display device of claim 7, wherein both of the first and second switching elements of a liquid crystal cell are connected to the same gate line.

14. The liquid crystal display device of claim 7, wherein the pixel electrode extends over a pre-stage gate line to form a storage capacitor.

15. A method for driving a liquid crystal display panel having a plurality of gate lines and a plurality of data lines crossing each other to define liquid crystal cells, first switching elements in the liquid crystal cells connected to a data line, second switching elements in the liquid crystal cells connected to a common voltage, and pixel electrodes connected to the first and second switching elements, the method comprising:
supplying data signals to the liquid crystal cells through the first switching elements in response to first gate signals; and
supplying a common voltage to the liquid crystal cells through the second switching elements in response to second gate signals.

16. The method of claim 15, wherein the supplying the data signals to the liquid crystal cells is performed by the second switching element being turned off by the first gate signals.

17. The method of claim 15, wherein the supplying the common voltage to the liquid crystal cells is performed by the first switching element being turned off by the second gate signals.

18. The method of claim 15, wherein the first and second switching elements include transistors.

19. The method of claim 18, wherein the first switching elements include an n-type thin film transistor, and the second switching elements include a p-type thin film transistor.

20. The method of claim 18, wherein the first switching elements include a p-type thin film transistor, and the second switching elements include an n-type thin film transistor.

21. The method of claim 15, wherein both of the first and second switching elements of the liquid crystal cells are connected to the same gate line.

22. The method of claim 15, wherein the pixel electrode extends over a pre-stage gate line to form a storage capacitor.
